(19) United States
(12) Patent Application Publication
(10) Pub. No.: US 2015/0121896 A1
(43) Pub. Date: May 7, 2015

(54) REVERSE CORE FLOW ENGINE MOUNTING ARRANGEMENT

(71) Applicant: United Technologies Corporation, Hartford, CT (US)

(72) Inventors: Gabriel L. Suciu, Glastonbury, CT (US); Jesse M. Chandler, South Windsor, CT (US); Brian D. Merry, Andover, CT (US)

(73) Assignee: United Technologies Corporation, Hartford, CT (US)

(21) Appl. No.: 14/190,162

(22) Filed: Feb. 26, 2014

Related U.S. Application Data
(60) Provisional application No. 61/773,871, filed on Mar. 7, 2013.

(51) Int. Cl. F02C 7/20; F02K 1/54

(52) U.S. Cl. CPC F02C 7/20; F02K 1/54
USPC 60/796

(57) ABSTRACT

A mounting arrangement for an aircraft engine includes a mounting structure attached to an aircraft body and not directly connected to an engine core of the aircraft engine, a propulsor mounted to the mounting structure, and a thrust reverser mounted directly to either the propulsor or mounting structure.

CROSS-REFERENCE TO RELATED APPLICATION(S)

This application claims priority from U.S. Provisional Application No. 61/773,871, filed Mar. 7, 2013, for “REVERSE CORE FLOW ENGINE MOUNTING ARRANGEMENT”.

### BACKGROUND

The present invention relates generally to gas turbine engines, and more specifically to gas turbine engine mounting arrangements.

Ducted fan gas turbine engines for powering an aircraft are typically mounted upon and suspended from the aircraft via a pylon structure. The pylon extends from the aircraft frame, such as a wing, and a mounting arrangement interconnects the engine to the pylon and so to the aircraft. One conventional type of mounting arrangement is the so-called core mount, where the pylon extends through the engine nacelle, across the by-pass duct towards the core engine casing. The mounting arrangement then interconnects the core engine casing, and so core engine, to the pylon. Generally both a front or forward mounting in the region of the compressor section of the core engine and a rear mounting in the region of the turbine section of the engine are used to connect the core engine to the pylon at two axially separated locations. The fan casing and nacelle may either be independently connected to the pylon or, more typically are supported from and by the core engine casing and core engine mountings.

The mountings for an engine are required to carry and transmit all of the operating loads of the engine including side, vertical, axial (thrust) and torque loads.

### SUMMARY

In one embodiment, a mounting arrangement for an aircraft engine includes a mounting structure attached to an aircraft body and not directly connected to an engine core of the aircraft engine, a propulsor mounted to the mounting structure, and a thrust reverser mounted directly to either the propulsor or mounting structure.

In another embodiment, an aircraft includes an aircraft body, a propulsor mounted to the aircraft body and not directly connected to an engine core of the aircraft engine, and a thrust reverser mounted directly to the propulsor.

### BRIEF DESCRIPTION OF THE DRAWINGS

FIG. 1 is a perspective view of an aircraft with conjoined engines mounted on the rear of the fuselage.

FIG. 2 is a schematic view of a reverse core engine.

FIG. 3 is an exploded perspective view of the conjoined engines and thrust reversers.

FIG. 4 is an exploded perspective view of a reverse core engine propulsor and thrust reverser.

FIG. 5 is an exploded schematic view of a first embodiment of a propulsor and thrust reverser being mounted under an aircraft wing.

FIG. 6 is an exploded schematic view of a second embodiment of a propulsor and thrust reverser being mounted under an aircraft wing.

### DETAILED DESCRIPTION

A thrust reverser is mounted on an airframe, not directly to the engine or engine frame. That is, it is mounted directly on the aircraft frame or propulsor, taking the load off of the core engine structure. Thus, a mounting pylon is not needed as is typical for prior art configurations.

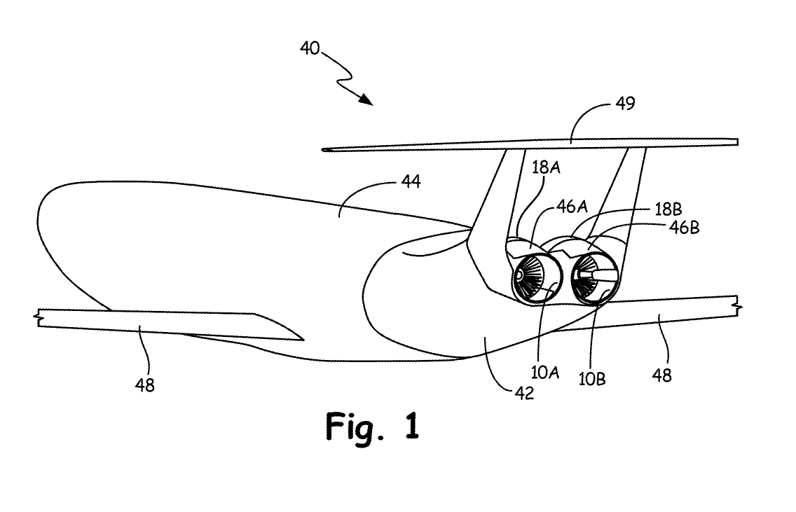

FIG. 1 illustrates an aircraft 40 with wings 48, and conjoined engines 10A and 10B mounted on a rear 42 of a fuselage 44. The aircraft has mounting locations for engines 10A and 10B between a portion of a tail 49. At the mounting location, certain positioning restrictions are present on the engine. Conjoined engines 10A and 10B each have nacelles 18A and 18B that are attached to, or that include, thrust reversers 46A and 46B. The thrust reversers 46A and 46B contain flow blocking doors that may be deployed to inhibit and reverse the flow of the engines 10A and 10B. Nacelles 18A and 18B are directly connected to the fuselage 44 of aircraft 40.

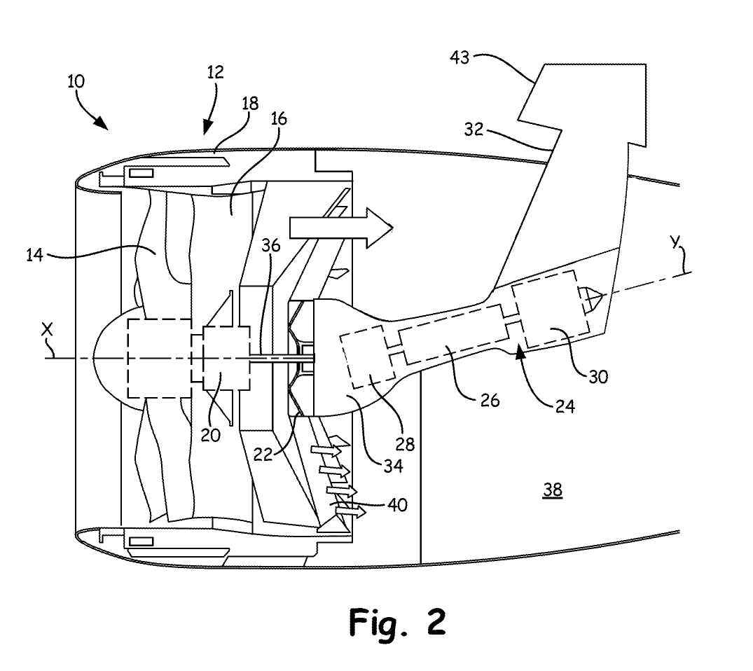

FIG. 2 is a plan schematic view of a reverse core engine. Engine 10 includes a propulsor 12 at a forward end which is centered for rotation about an axis X. Propulsor 12 includes a fan 14 and a nozzle 16 rearward thereof surrounded by a nacelle 18. Axis X is also a central axis of the fan and the nozzle. Engine 10 may include a gear reduction 20 driven by a power turbine section 22 to drive the fan 14.

A core engine 24 includes combustion section 26 positioned between a turbine section 28 and a compressor section 30. The core engine 24 may also be referred to as the gas generator of the turbine engine. Air passes into an inlet duct 32 to be delivered to the compressor 30. The duct 32 has a limited cross sectional area. At other circumferential locations within nacelle 18, air flows as bypass air for propulsion. The air is compressed and delivered into combustion section 26, where it mixes with fuel and is ignited. Products of this combustion pass through turbine section 28, which drives compressor section 30. The products of combustion then pass through a transition duct 34 over power turbine section 22, to drive the fan 14 that is connected by thereto by a propulsor shaft 36. Air then exits the power turbine 22 and is exhausted therefrom, such as by having a turbine nozzle that directs the flow aftward upon leaving the power turbine 22. The exhaust from the core engine 24 may be mixed with the bypass flow from the propulsor 12 as it leaves the power turbine 22, creating a single exhaust airflow from engine 10.

The illustrated gas turbine engine is a “reverse flow engine” in that the compressor 30 is positioned further into (forward to aft) the engine than is the turbine 28. That is, the turbine section 28 is closest to the propulsor 12, the combustor section 26 and the compressor section 30 are positioned further away in the downstream or aft direction of the propulsor 12 relative to the turbine section 28.

The engine 10 is positioned such that the fan 12, the gear 20, and the power turbine 22 are positioned centered on the axis X, while the core engine 24, including the compressor section 26, the combustor section 24, and the turbine section 28, is positioned on a non-parallel axis Y. The core engine 24 may be mounted in some manner to the nozzle 16, such as through transition duct 34.

In an engine that is reverse flow, and in particular in one wherein the axes X and Y are not parallel, a relatively long core engine 24 can be achieved without the core engine blocking the exit area 38. However, the overall length of the engine 10 is reduced as the core engine 24 is mounted at an angle with respect to the propulsor 12.

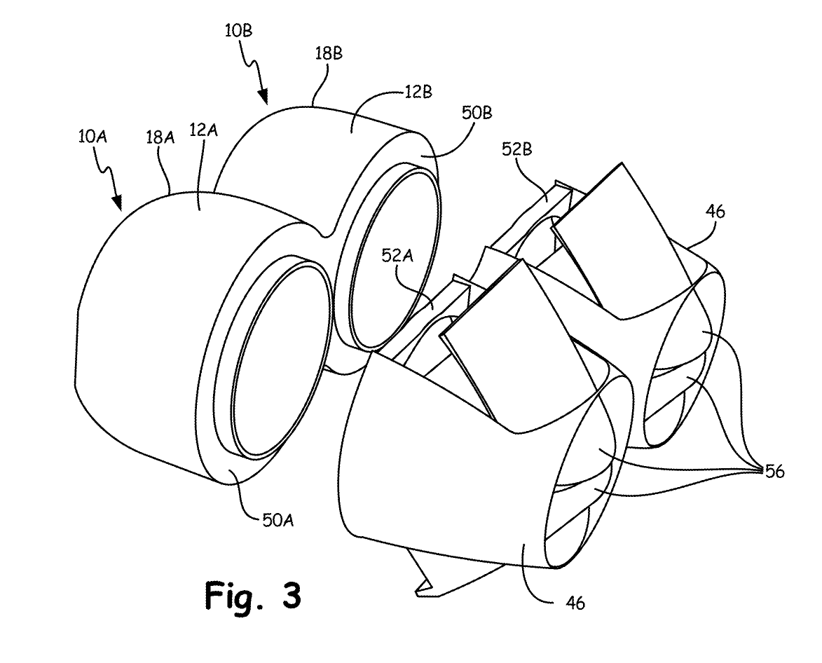

FIG. 3 is a perspective view of the conjoined engines 10A and 10B with thrust reversers 46A and 46B with blocker doors 56. The conjoined engines 10A and 10B each contain the propulsors 12A and 12B covered by nacelles 18A and 18B, respectively, and may be reverse core flow engines previously described. The propulsors 12A and 12B will be mounted directly to the fuselage 44 of aircraft 40. Once the propulors 12A and 12B are secured, the thrust reversers 46A and 46B are mounted directly to the propulors 12A and 12B and secured with common fasteners, such as bolts, pins, rivets, and the like. Specifically, the outer frames 52A and 52B of the thrust reversers 46A and 46B are secured to step flanges 50A and 50B on the propulsors 12A and 12B, respectively. In one embodiment, the nacelle 18 is directly attached to the fuselage 44, while in an alter embodiment the nacelle is bolted to the outer perimeter of the propulsor 12. With this mounting arrangement, the thrust reversers 46A and 46B are secured without attachment to the core engine(s) 24, thus taking the load off of the core engine structure. The pylon structure of the prior art designs is eliminated, thus saving weight on the aircraft. Reduced weight of an aircraft proportionally reduces the amount of fuel burned during flight, making the aircraft much more cost effective.

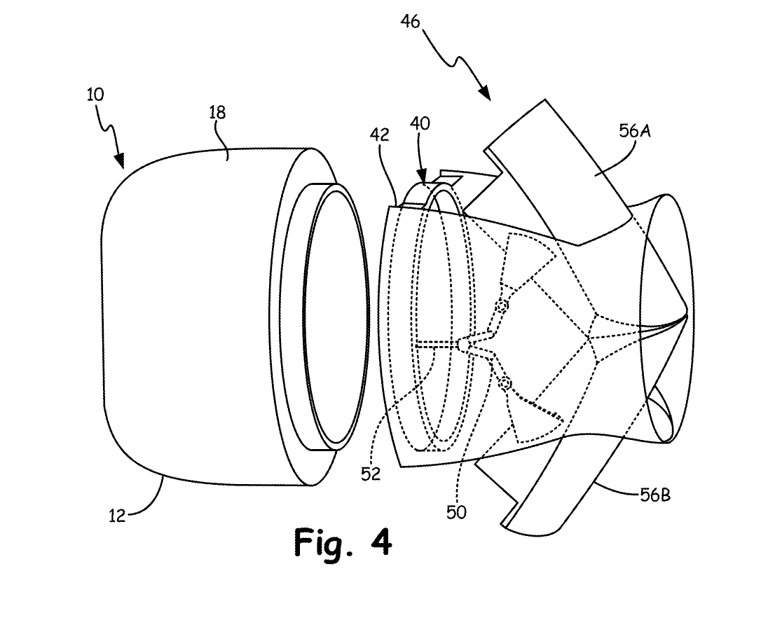

FIG. 4 is a perspective view of one of the conjoined engines 10 with thrust reverser 46 in a deployed position. The doors 56A and 56B are pivoted to a deployed position to block the exit area of the engine 10. The propulsor 12 and turbine section 28 continue to deliver exhaust gas against the deployed doors 56A and 56B, and create a reverse thrust tending to slow the aircraft. With this configuration, the pivoting doors 56A and 56B are centrally located adjacent either at the top dead center or bottom dead center of the engine 10. When deployed, the thrust reverser 46 will move the pivoting doors 56A and 56B in a general vertical direction. Once an aircraft associated with the engine 10 has landed, the actuation mechanism 52 drives the linkage system 50 into a deployed position to activate the thrust reversers 46.

Once in the deployed position, the doors 56A and 56B will block both the bypass flow from the propulsor 12 and the exit flow from the turbine 28. The angle of the core engine 24 allows for the full closure or pivoting of the doors 56A and 56B behind the core engine 24 while not interfering or disrupting inlet flow from the side thereof, or contacting the core engine 24 in the deployed position. The angled core engine 24 shortens the overall length of the engine 10. The system provides enhances thrust reverse for the engine 10 as only one structure is needed to block both bypass flow and core engine exhaust flow due to the shortened length of the engine. Further, fewer parts are required for the engine as the doors of the thrust reverser are incorporated into the nacelle or cowl and serve a dual function. As a result, the weight of the engine is greatly reduced, and thus the thrust reverser 46 arrangement proportionally reduces the amount of fuel burned during flight. With the reduction of weight and in the number of components for the thrust reverser 46, the direct attachment to the propulsor 12 is able to handle all forces, including side, thrust, and torque loads, without requiring attachment to the core engine 24.

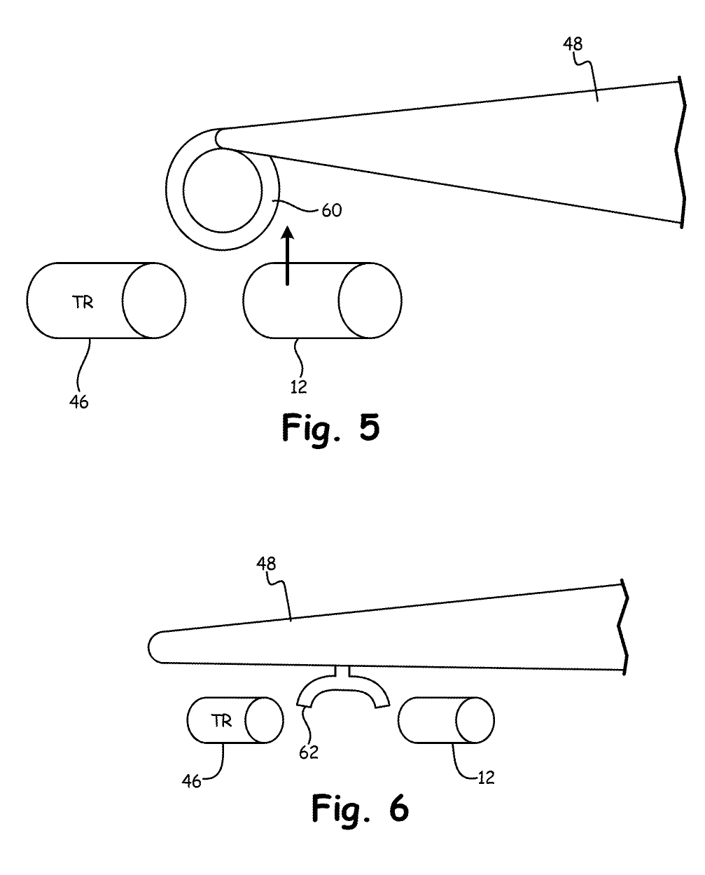

FIG. 5 is an exploded schematic view of an embodiment of the propulsor 12 and the thrust reverser 46 being mounted under the aircraft wing 48. The wing 48 is part of the aircraft frame of aircraft 40. The tip of the wing contains a mounting ring 60 that is part of the aircraft frame. The propulsor 12 is mounted to a forward side of the mounting ring 60, and the thrust reverser 46 is mounted to the aft side thereof. Both the thrust reverser 46 and the propulsor 12 are secured using permanent, semi-permanent, or removable fasteners. Again, the core engine 24 is not secured directly to the airframe, but is secured through attachment to the nacelle 18 or the propulsor 12.

FIG. 6 is an exploded schematic view of a second embodiment of the propulsor 12 and the thrust reverser 46 being mounted under the aircraft wing 48. The wing 48 is part of the aircraft frame of aircraft 40. The wing contains a mounting member 62 that is part of the aircraft frame, which may be arc shaped. The propulsor 12 is mounted to a forward side of the mounting member 62, and the thrust reverser 46 is mounted to the aft side thereof. A portion of the thrust reverser 46 is also attached directly to the propulsor 12. Both the thrust reverser 46 and the propulsor are secured using permanent, semi-permanent, or removable fasteners. The core engine 24 is not secured with respect to the airframe. The nacelle 18 may be mounted around the propulsor 12.

With the under wing mounting arrangement, the thrust reverser 46 is secured without attachment to the core engine 24, thus taking the load off of the core engine structure. The pylon structure of the prior art designs is eliminated, thus saving weight on the aircraft. In an engine that is reverse flow, and in particular in one wherein the axes X and Y are not parallel, a relatively long core engine 24 can be achieved without the core engine 24 blocking the exit area 38. However, the overall length of the engine 10 is reduced as the core engine 24 is mounted at an angle with respect to the propulsor 12. This creates a shorter length necessary for the cowl and the thrust reverser 46 to cover in the stowed position. As such, the thrust reverser 46 is lighter, and requires less compensation than the forces associated with a longer, heavier component. Conversely, the core engine 24 may be smaller, and thus weigh less, as the nacelle loads are not being supported by the core engine 24. As stated prior, reduced weight of an aircraft proportionally reduces the amount of fuel burned during flight, thus making the aircraft much more cost effective.

### Discussion of Possible Embodiments

The following are non-exclusive descriptions of possible embodiments of the present invention.

In one embodiment, a mounting arrangement for an aircraft engine includes a mounting structure attached to an aircraft body and not directly connected to an engine core of the aircraft engine, a propulsor mounted to the mounting structure, and a thrust reverser mounted directly to either the propulsor or mounting structure.

The mounting arrangement of the preceding paragraph can optionally include, additionally and/or alternatively, any one or more of the following features, configurations and/or additional components:

wherein the mounting structure comprises a mounting ring attached to a wing of the aircraft body;

wherein the thrust reverser is mounted to a first side of the mounting ring, and the propulsor is mounted to a second side of the mounting ring;

wherein the mounting structure comprises an arc shaped member attached to a wing of the aircraft body;

wherein the thrust reverser is mounted to a first side of the arc shaped member, and the propulsor is mounted to a second side of the arc shaped member;

wherein the propulsor includes a nacelle;

wherein the nacelle is mounted to a rear of the fuselage of the aircraft body;

wherein the thrust reverser is mounted directly to the nacelle; and/or

the engine core mounted to the propulsor, the engine core including a compressor section, a combustor section, and a turbine section, with the turbine section being closer to the propulsor than the compressor section.

In another embodiment, an aircraft includes an aircraft body, a propulsor mounted to the aircraft body and not directly connected to an engine core of the aircraft engine, and a thrust reverser mounted directly to the propulsor.

The aircraft of the preceding paragraph can optionally include, additionally and/or alternatively, any one or more of the following features, configurations and/or additional components:

wherein the aircraft body comprises a mounting ring attached to a wing;

wherein the propulsor includes a nacelle;

wherein the nacelle is mounted to a rear of the fuselage of the aircraft body;

wherein the thrust reverser is mounted directly to the nacelle;

wherein the thrust reverser and nacelle are connected with removable fasteners; and/or

an engine core mounted to the propulsor, the engine core including a compressor section, a combustor section, and a turbine section, with the turbine section being closer to the propulsor than the compressor section.

Although the present invention has been described with reference to preferred embodiments, workers skilled in the art will recognize that changes may be made in form and detail without departing from the spirit and scope of the invention.

1. A mounting arrangement for an aircraft engine comprising:
a mounting structure attached to an aircraft body and not directly connected to an engine core of the aircraft engine;
a propulsor mounted to the mounting structure; and
a thrust reverser mounted directly to either the propulsor or mounting structure.

2. The engine mounting arrangement of claim 1, wherein the mounting structure comprises a mounting ring attached to a wing of the aircraft body.

3. The engine mounting arrangement of claim 2, wherein the thrust reverser is mounted to a first side of the mounting ring, and the propulsor is mounted to a second side of the mounting ring.

4. The engine mounting arrangement of claim 1, wherein the mounting structure comprises an arc shaped member attached to a wing of the aircraft body.

5. The engine mounting arrangement of claim 4, wherein the thrust reverser is mounted to a first side of the arc shaped member, and the propulsor is mounted to a second side of the arc shaped member.

6. The engine mounting arrangement of claim 1, wherein the propulsor includes a nacelle.

7. The engine mounting arrangement of claim 6, wherein the nacelle is mounted to a rear of the fuselage of the aircraft body.

8. The engine mounting arrangement of claim 7, wherein the thrust reverser is mounted directly to the nacelle.

9. The engine mounting arrangement of claim 1, further comprising the engine core mounted to the propulsor, the engine core including a compressor section, a combustor section, and a turbine section, with the turbine section being closer to the propulsor than the compressor section.

10. An aircraft comprising:
an aircraft body;
a propulsor mounted to the aircraft body and not directly connected to an engine core of the aircraft engine; and
a thrust reverser mounted directly to the propulsor.

11. The aircraft of claim 10, wherein the aircraft body comprises a mounting ring attached to a wing.

12. The aircraft of claim 10, wherein the propulsor includes a nacelle.

13. The aircraft of claim 12, wherein the nacelle is mounted to a rear of the fuselage of the aircraft body.

14. The aircraft of claim 13, wherein the thrust reverser is mounted directly to the nacelle.

15. The aircraft of claim 14 wherein the thrust reverser and nacelle are connected with removable fasteners.

16. The aircraft of claim 10, further comprising an engine core mounted to the propulsor, the engine core including a compressor section, a combustor section, and a turbine section, with the turbine section being closer to the propulsor than the compressor section.
